(19) United States
(12) Patent Application Publication
(10) Pub. No.: US 2024/0022196 A1
(43) Pub. Date: Jan. 18, 2024

(54) Electric machine with magnetic flux modulated at high frequency

(71) Applicant: Ravisekhar Raju, Clifton Park, NY (US)

(72) Inventor: Ravisekhar Raju, Clifton Park, NY (US)

(21) Appl. No.: 18/221,866

(22) Filed: Jul. 13, 2023

Related U.S. Application Data
(60) Provisional application No. 63/388,276, filed on Jul. 12, 2022.

(51) Int. Cl. H02P 27/04

(52) U.S. Cl. CPC H02P 27/04; H02P 2209/11

(57) ABSTRACT

An electric machine is provided in which the magnetic field in the air gap between the stator and the rotor rotates around the air gap while simultaneously reversing in polarity at a modulation frequency that is substantially higher than the rotational frequency of the field around the air gap. The magnetic field modulation is carried out by modulating the machine stator or rotor currents at a high frequency through a power converter or inverter. The high frequency modulation of the magnetic field can reduce the size of the machine.

### CROSS-REFERENCE TO RELATED APPLICATION

This application claims the benefit of U.S. Provisional Patent Application No. 63/388,276, titled ‘High frequency modulation of magnetic flux in an electric machine’ filed 12 Jul. 2022, which is incorporated by reference herein in its entirety.

### BACKGROUND

The present invention relates to the field of electrical power equipment. Specifically, the present invention relates to electric machines and a method of modulating magnetic flux in the electric machine that in effect superimposes a substantially fast continuous reversal of the magnetic poles in addition to their rotation around the air gap of the machine.

Electric machines are used in a wide range of applications, and it is desirable to improve their power density, i.e., reduce size or weight for a given power rating. The torque of a machine is proportional to D²LBA, with D and L being the diameter and length of the rotor, B being the magnetic loading and A being the electric loading. The magnetic loading, B, is a function of the magnetic flux density that the stator and rotor magnetic paths can handle without saturation or excessive losses. The electric or current loading, A, is a function of the ampere-turns that can be accommodated and is dictated by the ability to cool the windings. Many applications such as direct-drive wind turbine generators and ship propulsion motors operate at low rpms and involve very high torques, which leads to a large size and weight for the electric machines. Therefore, what is needed are techniques that can improve the power density of electric machines.

Electric machines based on prior art often use a rotating magnetic field. The rotating magnetic field is, for example, created by feeding a three-phase stator winding with three-phase alternating currents. The speed of the rotating magnetic field is set by the fundamental electrical frequency and the number of poles, with speed of the rotating magnetic field in rpm=(120.f)/p. The rotating field created by the stator currents interacts with the rotor to create a torque. This can happen in various forms for different machines. For example, in an induction machine the rotating field set up by the stator currents induces currents in the rotor windings or bars, which in turn create a rotor field that reacts with the stator field to produce a torque.

### BRIEF SUMMARY OF THE INVENTION

Embodiments of the invention provide an electric machine with improved power density. In particular, the invention provides a magnetic field in the electric machine air gap, wherein the poles of the magnetic field, in addition to having a rotating action around the air gap, are also flipped/reversed continuously at a rate substantially faster than the speed of rotation. The resulting higher frequency of the magnetic field allows the stator core to be smaller in size thus improving the power density of the machine since a higher frequency operation can potentially reduce the magnetic flux to be accommodated in the machine stator core.

According to another aspect of the invention, the stator current waveforms are modulated by a high frequency, and are substantially of the form Î·sin(ω_{f}t+Φ)·sin(ω_{hf}t), where ω_{f} is the fundamental frequency, Φ is the phase angle of the fundamental for the respective phases, and ω_{hf} is the modulating high frequency and Î is the current amplitude. This modulation of the stator waveforms results in the afore-mentioned continuous high speed flipping/reversals of the magnetic field in addition to its rotation.

According to one embodiment, the rotor of the machine consists of a squirrel-cage structure with a substantially small air gap such that leakage inductance of the machine is substantially reduced. The low leakage inductance improves coupling of the rotor and the stator electromagnetic circuits such that the induced rotor currents are also flipped at a high frequency in near synchronism with the stator current high frequency modulation.

According to yet another aspect of the invention, the rotor of the machine consists of windings fed from an external source or power converter and wherein the external source or power converter controls the rotor current waveforms such that they are high frequency modulated and create a rotor magnetic field that flips in substantially synchronism with the stator magnetic field and also rotates.

According to yet another aspect of the invention, the rotor of the machine consists of a soft magnetic core with saliency in the reluctance such that the rotating and flipping stator magnetic field interacts with the rotor and produces a reluctance torque.

Various other features and advantages will be made apparent from the following detailed description and the drawings.

### BRIEF DESCRIPTION OF THE DRAWINGS

The present invention is illustrated by way of example and not limitation in the figures of the accompanying drawings in which like references indicate similar elements.

FIG. 1 illustrates an electrical machine according to prior art where the stator consists of three-phase windings which are excited with sinusoidal currents at the fundamental supply frequency. The stator windings with phase angle-displaced currents produce a rotating magnetic field.

FIG. 2 illustrates an embodiment of the present invention where the stator windings are fed with currents that are modulated at a high frequency in addition to their fundamental frequency. This results in a magnetic field that is flipping/reversing continuously at a rate substantially higher than the fundamental frequency in addition to the rotating action around the air gap of the machine.

FIG. 3 illustrates an embodiment of the present invention wherein the rotor of the electric machine contains a set of conductors that are fed from an external supply or are connected to form a closed circuit for carrying induced currents.

FIG. 4 illustrates an embodiment of the present invention wherein the rotor of the electric machine comprises a soft magnetic core with saliency in the magnetic reluctance.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” or “another embodiment” means that a particular feature, structure, or characteristic described in conjunction with the embodiment can be included in at least one embodiment of the invention.

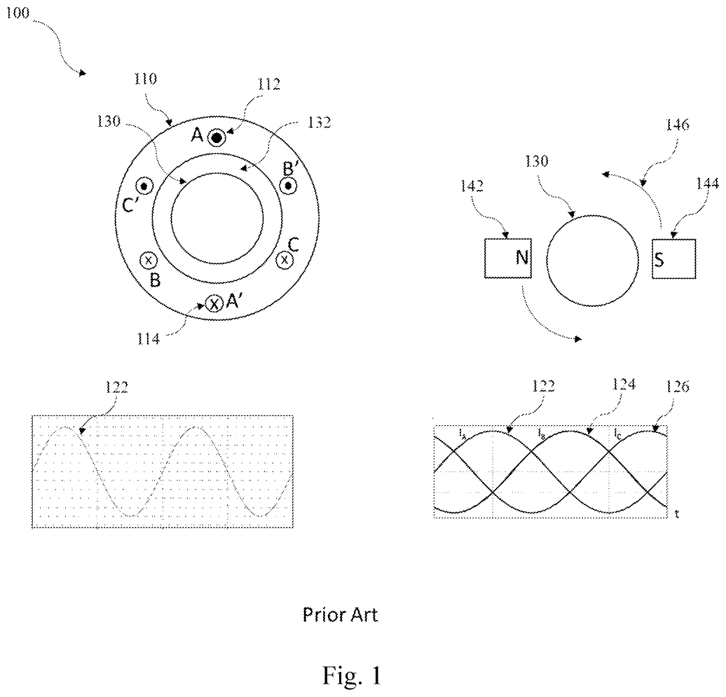

FIG. 1 illustrates an electrical machine 100 according to prior art wherein the stator 110 contains three-phase windings which are excited with substantially sinusoidal currents at a frequency equal to the fundamental frequency of the grid or supply system connected to the machine. Phase A windings represented by 112 and 114 carry current Ia shown in waveshape 122, while phases B and C carry currents Ib and Ic that are shown by the phase-angle displaced waveshapes 124 and 126 respectively. At any instant, the three-phase currents produce a magnetic field in the air gap 132 between the stator 110 and rotor 130 of the machine. This, in case of a machine wound with a two-pole configuration, effectively creates a pair of magnetic poles 142 and 144. With the varying relative amplitudes of the three-phase currents over an alternating current (AC) cycle, the pair of magnetic poles revolve circumferentially around the air gap with the rotation of the magnetic field denoted by 146. In the case of a synchronous motor, the stator rotating field can interact with the field due to permanent magnets or field windings in the rotor to develop a torque. In the case of an induction motor, the stator rotating field can induce currents in rotor windings/bars which thereby creates a rotor field that interacts with the stator field to develop a torque.

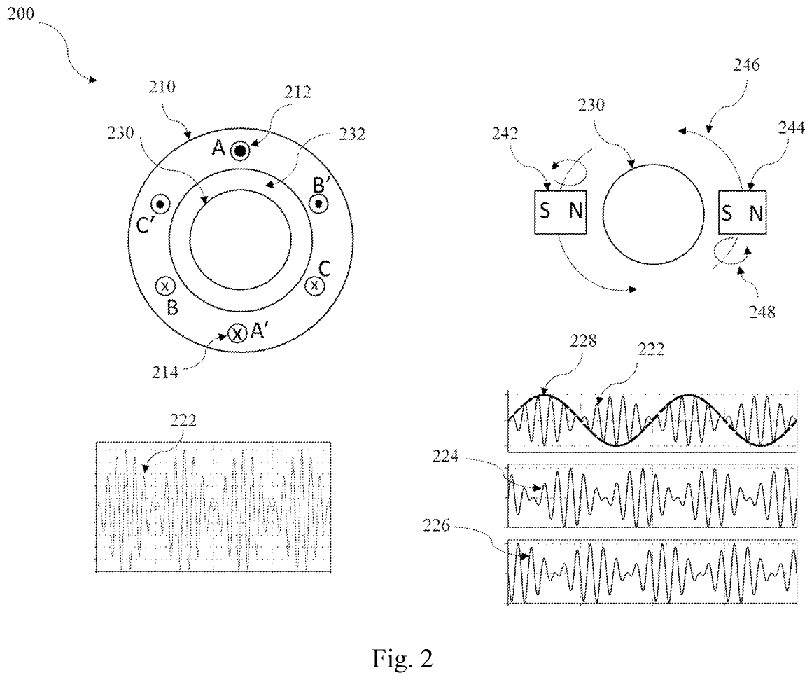

FIG. 2 illustrates an electric machine 200 and its waveforms according to an embodiment of the present invention. The stator 210 consists of a set of polyphase windings, for example three-phase windings for phases A, B, and C. The winding for phase A, as an example, consists of conductor 214 and return path conductor 212 in the stator slots. The rotor 230 and stator 210 are separated by an air gap 232 in which a magnetic field is established by the currents in the stator or rotor windings. The phase A stator current according to an embodiment of the present invention is shown by the waveform 222. Waveform 222 comprises a high frequency modulation of the fundamental frequency sine waveform 228. In a similar fashion phases B and C have a high frequency modulated current waveshape shown by 224 and 226. The fundamental frequency envelopes for the modulated three phase currents are displaced from each other by 120 degrees of an electrical cycle. As a result of this high frequency modulation of the currents, the magnetic field not only rotates around the air gap as shown by the rotational action 246 but the magnetic poles in the air gap represented by 242 and 244 also continuously reverse/flip at a substantially higher rate than the rotational speed. The speed of the reversal/flipping of polarity shown through action 248 is determined by the modulation frequency. The high speed reversal/flipping results in operation of the machine at a higher magnetic field frequency, which can improve the power density of the machine since a higher frequency operation can potentially reduce the magnetic flux to be accommodated in the machine stator core. The high frequency modulated currents can be supplied by a power converter or inverter with controlled power switching devices.

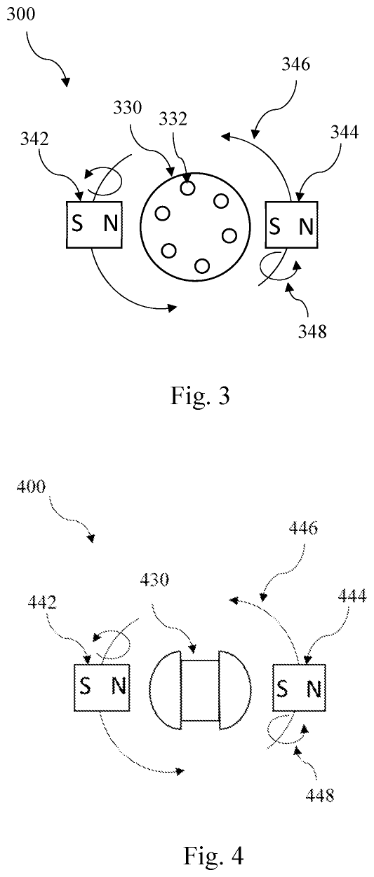

FIG. 3 shows an embodiment of the present invention in which the machine rotor 330 includes a set of windings with conductors, for example, 332. The windings can be connected to an external circuit or supply or can form a closed circuit within the rotor. The magnetic poles, 342 and 344, set up in the air gap have a rotational action, 346, as well as a reversal/flipping action, 348, that is substantially faster than the rotational action. The mechanical speed of the rotor is determined by the speed of the rotational action of the magnetic field 346 while the magnetic flux frequency is related to the speed of the reversals/flipping shown by 348.

FIG. 4 illustrates an embodiment of the present invention in which the machine rotor 430 consists of a soft magnetic core with a high degree of saliency, i.e., the magnetic reluctance is anisotropic with variation along different angles. In applications of the machine as a motor, the rotor will align with the magnetic poles 442 and 444 at an angle dependent on the machine torque and rotate along with the poles at the same speed as that of the rotational action 446 of the poles. A reluctance torque will be generated due to the interaction of the magnetic path saliency with the magnetic field produced by the stator currents.

The foregoing description of exemplary embodiments of the invention has been presented for the purposes of illustration and description. It is not intended to be exhaustive or to limit the invention to the precise forms disclosed. It will be recognized by those skilled in the art that many modifications and variations are possible without departing from the essential scope of the invention. It is, therefore, to be understood that the scope of the invention is not limited to the particular embodiments disclosed, and that the invention will include all embodiments falling within the scope of the claims appended hereto.

What is claimed is:

1. An electric machine comprising a stator, a rotor and windings for carrying current in at least one of the stator or rotor,
wherein a magnetic field couples the stator and rotor across an air gap between said stator and said rotor,
and wherein the said magnetic field rotates around the said air gap and also has continuous reversals in its polarity at a rate substantially faster than the speed of its said rotation around the air gap,
and wherein the speed of the said rotation of the magnetic field is determined by the fundamental frequency of the alternating current supply or system to which the electric machine is connected.

2. The electric machine of claim 1, wherein the stator comprises windings carrying stator currents,
and wherein the said stator currents have waveforms with an envelope at the said fundamental frequency,
and wherein the said stator currents are modulated at a substantially higher frequency than the said fundamental frequency such that they are continuously reversed in direction at the said higher modulating frequency while substantially tracking in amplitude the fundamental frequency envelope.

3. The electric machine of claim 2, wherein the stator currents are supplied from a power converter or inverter.

4. The electric machine of claim 1,
wherein the rotor comprises a soft magnetic material that can be magnetized in sympathy with the magnetic field across the air gap,
and wherein the said magnetic field across the air gap is rotating around the air gap and continuously reversing in polarity at a rate substantially faster than the speed of its said rotation.

5. The electric machine of claim 4,
wherein the rotor comprising soft magnetic material has an anisotropic reluctance to provide rotor magnetic path saliency,
and wherein the rotor magnetic path saliency interacts with the magnetic field produced by the stator currents to produce a reluctance torque.

6. The electric machine of claim 2, wherein the rotor comprises windings or bars which have induced or externally fed currents that follow a fundamental frequency envelope and are modulated at a higher frequency within the fundamental frequency envelope such that they are reversed in direction at the said higher frequency, and wherein the magnetic field produced by the stator currents interacts with the rotor currents to develop a torque.
